(19) United States
(12) Patent Application Publication
(10) Pub. No.: US 2022/0141351 A1
(43) Pub. Date: May 5, 2022

(54) ASSOCIATING BIOMETRIC USER CHARACTERISTICS WITH DOCUMENT PROCESSING JOBS

(71) Applicant: Hewlett-Packard Development Company, L.P., Spring, TX (US)

(72) Inventors: Steven Holland, Boise, CA (US); Kathryn Rachael Williams, Boise, CA (US); Marcos Teres Nieto, Boise, CA (US); Anoop Achuthan Rajendrababu, Boise, CA (US)

(73) Assignee: Hewlett-Packard Development Company, L.P., Spring, TX (US)

(21) Appl. No.: 17/311,855

(22) PCT Filed: Jul. 15, 2019
(86) PCT No.: PCT/US2019/041829

§ 371 Date: Jun. 8, 2021

(51) Int. Cl. H04N 1/44; G06V 40/10; G06V 40/50

(52) U.S. Cl. CPC H04N 1/442; G06V 40/50; G06V 40/10; H04N 1/4433

(57) ABSTRACT

Examples disclosed herein relate to receiving a request to perform a document processing job, capturing a biometric user characteristic associated with the request via a biometric authentication component, and creating a log entry comprising the biometric user characteristic and a plurality of details associated with the document processing job.

### BACKGROUND

Multi--function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates).

### BRIEF DESCRIPTION OF THE DRAWINGS

FIG. 1 is a block diagram of an example computing device for associating biometric user characteristics with document processing jobs.

FIG. 2 is a block diagram of an example system for associating biometric user characteristics with document processing jobs.

FIG. 3 is a flowchart of an example method for associating biometric user characteristics with document processing jobs.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Most multi-function-print devices (MFPs) provide several features, such as an option to perform document operations such as printing a document, scanning and/or copying a physical document, modifying electronic versions of a document, and/or sending an electronic copy of a document (e.g., via fax and/or email). Such operations may be controlled via an on-device control panel, a connected application, and/or a remote service. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

Some MFPs may allow and/or require users to login and/or otherwise authenticate before performing operations on the device. For example, a user may enter a username and password on a control panel, present an access card such as a radio frequency identification (RFID) enabled card, and/or authenticate via a biometric verification. Biometric verification may comprise a technique by which a person may be uniquely identified by evaluating one or more distinguishing biological traits. Unique identifiers comprise, for example, fingerprints, hand geometry, earlobe geometry, retina and iris patterns, voice and/or audio waves, DNA, and signatures.

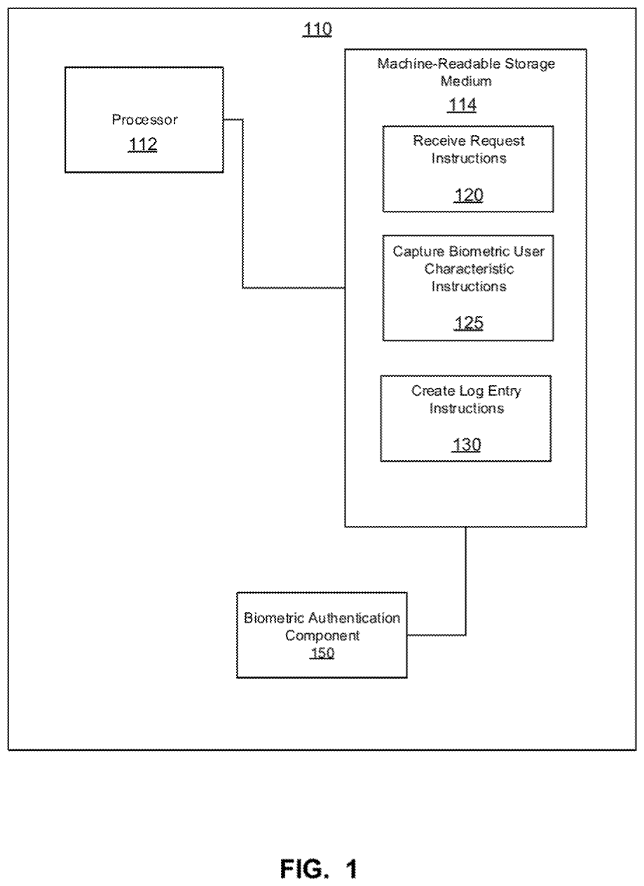

FIG. 1 is a block diagram of an example computing device 110 for associating biometric user characteristics with document processing jobs. Computing device 110 may comprise a processor 112 and a non-transitory, machine-readable storage medium 114. Storage medium 114 may comprise a plurality of processor-executable instructions, such as receive request instructions 120, capture biometric user characteristic instructions 125, and create log entry instructions 130. In some implementations, instructions 120, 125, 130 may be associated with a single computing device 110 and/or may be communicatively coupled among different computing devices such as via a direct connection, bus, or network. Device 110 may further comprise a biometric authentication component operative to capture biometric user characteristics, such as a camera, a fingerprint reader, a hand geometry scanner, an ocular scanner configured to capture iris and/or retina characteristics, a signature pad, and/or a voice capture component (e.g., a microphone).

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 125, 130.

Executable instructions 120, 125 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Receive request instructions 120 may receive a request to perform a document processing job. For example, a user may send a print job (e.g., may select a document to be printed, copied, faxed, etc.) to device 110 comprising a multi-function printer (MFP). For another example, a user may place a physical document into and/or onto the MFP and request a copy, scan, and/or fax of the document.

In some implementations, the request to perform the document processing job may comprise a plurality of actions. For example, the user may request that a document be scanned, stored as an electronic copy at a storage location, such as in a cloud storage service, and emailed to the user and/or another user(s).

Capture biometric user characteristic instructions 125 may capture a biometric user characteristic associated with the request via a biometric authentication component. For example, the biometric characteristic may comprise a face image, a voice, a fingerprint, an iris and/or retinal scan, and/or other biological characteristic of the user. In some implementations, the biometric user characteristic associated with the request may comprise a photo of a user who creates the request to perform the document processing job captured by a camera comprising the biometric authentication component.

In some implementations, instructions 125 to capture the biometric user characteristic may further comprise instructions to authenticate a user associated with the biometric user characteristic via the biometric authentication component. Such instructions to authenticate the user associated with the biometric user characteristic may, for example, comprise instructions to compare the biometric user characteristic to a stored biometric user characteristic associated with a user profile for a user who creates the request to perform the document processing job. In some implementations, the biometric user characteristic may be stored and associated with the requested print job without being authenticated.

In some implementations, the document processing job may comprise insertion of a watermark associated with the biometric user characteristic into a document associated with the document processing job. For example, details about the biometric user characteristic may be encoded as a matrix code, bar code, and/or steganographic pattern as an image on the document. When a physical copy of the document is produced, such a watermark may be detectable, such as by a barcode or other scanner, and the encoded data may comprise details identifying the user and/or the biometric user characteristic.

Create log entry instructions 130 may create a log entry comprising the biometric user characteristic and a plurality of details associated with the document processing job. For example, a log may be stored by device 110 of each print job requested and/or performed by device 110 that may comprise some or all elements such as identifying the document, details of the job (e.g., what operations were performed, time and date stamps, etc.), the biometric user characteristic, identification of the user, whether the user was authenticated, etc. In some implementations, the plurality of details associated with the document processing job may comprise at least one of the following: a job type (e.g., print, scan, fax, copy, etc.), a document type (e.g., photo, image, text, file type, etc.), a date of the request, a time of the request, a device identifier, and a user identifier.

In some implementations, instructions 130 to create the log entry may comprise instructions to create a plurality of log entries, wherein each of the plurality of log entries is associated with a respective one of a plurality of actions associated with the request to perform the document processing job. For example, if the job request is to scan, print a copy, and email an electronic copy of the document, a separate log entry may be created for each of the scan, print, and email steps. In some implementations, the printed and emailed copies may comprise an encoded watermark identifying the user and/or the captured biometric user characteristic as described above.

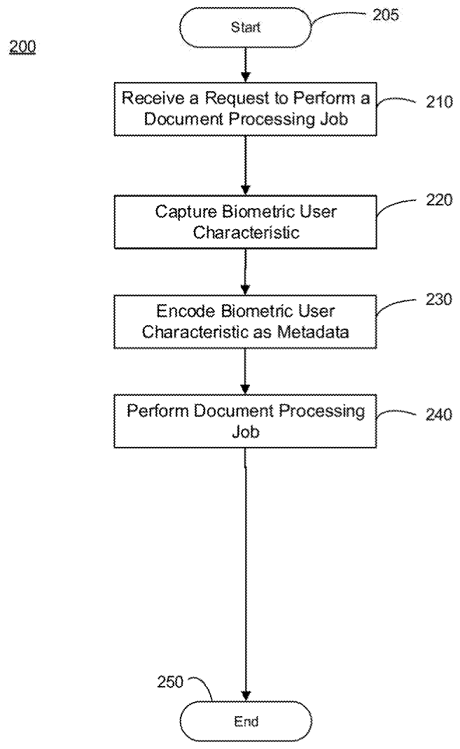

FIG. 2 is a flowchart of an example method 200 for associating biometric user characteristics with document processing jobs. Although execution of method 200 is described below with reference to computing device 110, other suitable components for execution of method 200 may be used.

Method 200 may begin at stage 205 and advance to stage 210 where device 110 may receive a request to perform a document processing job by the device. For example, the document processing job may comprise at least one of the following: a copy operation, a scan operation, a transmission operation, and a print operation.

In some implementations, device 110 may execute receive request instructions 120 to receive a request to perform a document processing job. For example, a user may send a print job (e.g., may select a document to be printed, copied faxed, etc.) to device 110 comprising a multi-function printer (MFP) For another example, a user may place a physical document into and/or onto the MFP and request a copy, scan, and/or fax of the document.

In some implementations, the request to perform the document processing job may comprise a plurality of actions. For example, the user may request that a document be scanned, stored as an electronic copy at a storage location, such as in a cloud storage service, and emailed to the user and/or another user(s).

Method 200 may then advance to stage 220 where computing device 110 may capture a biometric user characteristic from a user associated with the request. For example, device 110 may execute capture biometric user characteristic instructions 125 to capture a biometric user characteristic associated with the request via a biometric authentication component. For example, the biometric characteristic may comprise a face image, a voice, a fingerprint, an iris and/or retinal scan, and/or other biological characteristic of the user. In some implementations, the biometric user characteristic associated with the request may comprise a photo of a user who creates the request to perform the document processing job captured by a camera comprising the biometric authentication component.

In some implementations, instructions 125 to capture the biometric user characteristic may further comprise instructions to authenticate a user associated with the biometric user characteristic via the biometric authentication component. Such instructions to authenticate the user associated with the biometric user characteristic may, for example, comprise instructions to compare the biometric user characteristic to a stored biometric user characteristic associated with a user profile for a user who creates the request to perform the document processing job. In some implementations, the biometric user characteristic may be stored and associated with the requested print job without being authenticated.

Method 200 may then advance to stage 230 here computing device 110 may encode the biometric user characteristic as metadata associated with an electronic version of a document associated with the document processing job. The electronic version of the document may comprise electronic data representing a document in a pre-rendered or post-rendered format. A post-rendered document may comprise document data that has been translated into printer control language instructions for printing.

The electronic version of the document may be received from e user (e.g., transmitted from a computer for printing) and/or captured by the device (e.g., via a scanner.) In some implementations, the document processing job may comprise insertion of a watermark associated with the biometric user characteristic into a document associated with the document processing job. In some implementations, encoding the biometric user characteristic as metadata may comprises adding a scannable code to the electronic version of the document. For example, details about the biometric user characteristic may be encoded as a matrix code, bar code, and/or steganographic pattern as an image on the document. When a physical copy of the document is produced, such a watermark may be detectable, such as by a barcode or other scanner, and the encoded data may comprise details identifying the user and/or the biometric user characteristic.

In some implementations, encoding the biometric user characteristic as metadata may comprise creating a log entry comprising the biometric user characteristic and a plurality of details associated with the document processing job. For example, device 110 may execute create log entry instructions 130 to create a log entry comprising the biometric user characteristic and a plurality of details associated with the document processing job. For example, a log may be stored by device 110 of each print job requested and/or performed by device 110 that may comprise some or all elements such as identifying the document, details of the job (e.g., what operations were performed, time and date stamps, etc.), the biometric user characteristic, identification of the user, whether the user was authenticated, etc. In some implementations, the plurality of details associated with the document processing job may comprise at least one of the following: a job type (e.g., print, scan, fax, copy, etc.), a document type (e.g., photo, image, text, file type, etc.), a date of the request, a time of the request, a device identifier, and a user identifier.

In some implementations, instructions 130 to create the log entry may comprise instructions to create a plurality of log entries, wherein each of the plurality of log entries is associated with a respective one of a plurality of actions associated with the request to perform the document processing job. For example, if the job request is to scan, print a copy, and email an electronic copy of the document, a separate log entry may be created for each of the scan, print, and email steps. In some implementations, the printed and emailed copies may comprise an encoded watermark identifying the user and/or the captured biometric user characteristic as described above.

Method 200 may then advance to stage 240 where computing device 110 may perform the document processing job. For example, a request to print a copy of a physical document place on a scanner of device 110 may result in device 110 capturing an electronic version of the document via the scanner and producing a second copy of the document.

Method 200 may then end at stage 250.

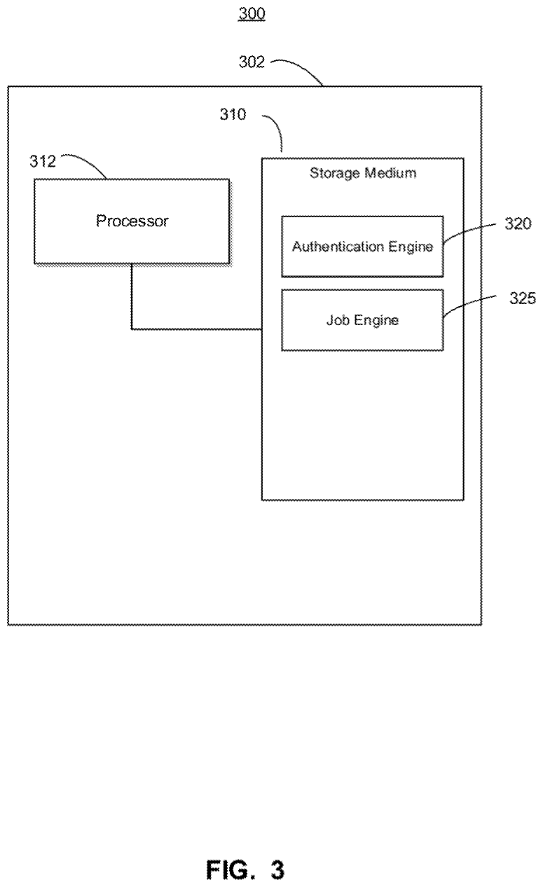

FIG. 3 is a block diagram of an example apparatus 300 for associating biometric user characteristics with document processing jobs. Apparatus 300 may comprise a multi-function printer device 302 comprising a storage medium 310, and a processor 312. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, an authentication engine 320 and a job engine 325.

Each of engines 320, 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325. In such examples, device 302 may comprise the machine-readable storage medium storing the Instructions and the processing resource to execute the instructions, or the machine-readable storage medium may be separate but accessible to apparatus 00 and the processing resource.

Authentication engine 320 may capture a biometric user characteristic associated with a user and authenticate the user according to the biometric user characteristic.

Authentication engine 320 may execute capture biometric user characteristic instructions 125 to capture the biometric user characteristic associated with the user via a biometric authentication component. For example, the biometric user characteristic may comprise a face image, a voice, a fingerprint, an iris and/or retinal scan, and/or other biological characteristic of the user. In some implementations, the biometric user characteristic associated with the request may comprise a photo of a user who creates the request to perform the document processing job captured by a camera comprising the biometric authentication component.

Authentication engine 320 may authenticate the user associated with the biometric user characteristic by, for example, comparing the captured biometric user characteristic to a stored biometric user characteristic associated with a user profile for a user who creates the request to perform the document processing job. Such a user profile may be identified as part of a request to perform the document processing job. For example, User X may request a document processing job comprising printing a document selected at their computer. A user account identifier associated with the user, such as a domain account used to log in to the computer, may be sent with the request to perform the document processing job. The user account identifier may be utilized to look up stored biometric data associated with the user that may then be compared to the captured biometric user characteristic. If the stored biometric user characteristic and captured biometric user characteristic are determined to be sufficiently similar, the user may be authenticated. In some implementations, the biometric user characteristic may be stored and associated with the requested print job without being authenticated.

Job engine 325 may receive a request to perform a document processing job on a document from the user, encode the biometric user characteristic for inclusion on the document associated with the request, and perform the document processing job.

For example, job engine 325 may execute receive request instructions 120 to receive a request to perform a document processing job. For example, a user may send a print job (e.g., may select a document to be printed, copied, faxed, etc.) to device 110 comprising a multi-function printer (MFP). For another example, a user may place a physical document into and/or onto the MFP and request a copy, scan, and/or fax of the document.

In some implementations, the request to perform the document processing job may comprise a plurality of actions. For example, the user may request that a document be scanned, stored as an electronic copy at a storage location, such as in a cloud storage service, and emailed to the user and/or another user(s).

In some implementations, inclusion of the encoded biometric user characteristic may comprise insertion of a watermark identifying the authenticated user onto the document. For example, performing the document processing job may comprise insertion of a watermark associated with the biometric user characteristic into a document associated with the document processing job. For example, details about the biometric user characteristic may be encoded as a matrix code, bar code, and/or steganographic pattern as an image on the document. When a physical copy of the document is produced, such a watermark may be detectable, such as by a barcode or other scanner, and the encoded data may comprise details identifying the user and/or the biometric user characteristic.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

1. A non-transitory machine readable medium storing instructions executable by a processor to:
receive a request to perform a document processing job;
capture a biometric user characteristic associated with the request via a biometric authentication component; and
create a log entry comprising the biometric user characteristic and a plurality of details associated with the document processing job.

2. The non-transitory machine readable medium of claim 1, wherein the biometric user characteristic associated with the request comprises a photo of a user who creates the request to perform the document processing job captured by a camera comprising the biometric authentication component.

3. The non-transitory machine readable medium of claim 1, wherein the plurality of details associated with the document processing job comprise at least one of the following: a job type, a document type, a date of the request, a time of the request, a device identifier, and a user identifier.

4. The non-transitory machine readable medium of claim 1, wherein the instructions to capture the biometric user characteristic further comprise instructions to authenticate a user associated with the biometric user characteristic via the biometric authentication component.

5. The non-transitory machine readable medium of claim 4, wherein the instructions to authenticate the user associated with the biometric user characteristic comprise instructions to compare the biometric user characteristic to a stored biometric user characteristic associated with a user profile for a user who creates the request to perform the document processing job.

6. The non-transitory machine readable medium of claim 1, wherein the biometric authentication component comprises at least one of the following: a camera, a fingerprint reader, a hand geometry scanner, an ocular scanner, a signature pad, and a voice capture component.

7. The non-transitory machine readable medium of claim 1, wherein the document processing job comprises insertion of a watermark associated with the biometric user characteristic into a document associated with the document processing job.

8. The non-transitory machine readable medium of claim 1, wherein the request to perform the document processing job comprises a plurality of actions.

9. The non-transitory machine readable medium of claim 8, wherein the instructions to create the log entry comprise instructions to create a plurality of log entries, wherein each of the plurality of log entries is associated with a respective one of the plurality of actions.

10. A method comprising:
receiving a request to perform a document processing job by a device;
capturing, by the device, a biometric user characteristic from a user associated with the request;
encoding the biometric user characteristic as metadata associated with an electronic version of a document associated with the document processing job; and
performing the document processing job.

11. The method of claim 10, wherein the document processing job comprises at least one of the following: a copy operation, a scan operation, a transmission operation, and a print operation.

12. The method of claim 11, wherein encoding the biometric user characteristic as metadata comprises adding a scannable code to the electronic version of the document.

13. The method of claim 11, wherein encoding the biometric user characteristic as metadata comprises creating a log entry comprising the biometric user characteristic and a plurality of details associated with the document processing job.

14. A system, comprising:
an authentication engine to:
capture a biometric user characteristic associated with a user, and
authenticate the user according to the biometric user characteristic; and
a job engine to:
receive a request to perform a document processing job on a document from the user,
encode the biometric user characteristic for inclusion on the document associated with the document, and
perform the document processing job.

15. The system of claim 14, wherein the inclusion of the encoded biometric user characteristic comprises insertion of a watermark identifying the authenticated user onto the document.
